(19) United States
(12) Patent Application Publication
(10) Pub. No.: US 2014/0007224 A1
(43) Pub. Date: Jan. 2, 2014

(54) REAL HUMAN DETECTION AND CONFIRMATION IN PERSONAL CREDENTIAL VERIFICATION

(71) Applicants: Ning Lu, Saratoga, CA (US); Achintya K. Bhowmik, Cupertino, CA (US); Michael M. Chu, Cupertino, CA (US)

(72) Inventors: Ning Lu, Saratoga, CA (US); Achintya K. Bhowmik, Cupertino, CA (US); Michael M. Chu, Cupertino, CA (US)

(21) Appl. No.: 13/539,034

(22) Filed: Jun. 29, 2012

(51) Int. Cl. H04L 9/32; G06F 21/00

(52) U.S. Cl. 726/19

(57) ABSTRACT

Real human detection and confirmation in personal credential verification is described. In one example, a camera image of a user is received at a computer system. The image is tested for recognition against a user account and it is confirmed that the image corresponds to a real human. If the image is authenticated and corresponds to a real human, then the user is authenticated to the corresponding user account of the computer system.

### BACKGROUND

Computer account log in protects computers from unauthorized users, but is an inconvenience to the authorized users. While some users log in once each day, others log in each time the system is allowed to go to sleep mode or each time the screen saver is activated. More frequent user authentication generally provides better security against unauthorized users but increases the inconvenience for authorized users. In some environments, there is a risk of unauthorized access each time the authorized user steps away from a terminal whether for a break or just to discuss something in the next office. With portable devices from notebook computers, to slate computers to telephones becoming more common, the risk of unauthorized access becomes greater.

Conventional user authentication requires a user to type a password, perhaps with a special key combination, such as Control, Alt, and Delete. In some systems, a fingerprint scanner is used instead of or in addition to the user password. Recently, it has been proposed to use a front facing camera, common on notebook computers and smart phones, to observe the face of the user and use the face as an authentication. The camera can authenticate the user simply by looking at the user.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a process flow diagram for authenticating a camera-based passive log in according to an embodiment of the invention.

FIG. 2 is a process flow diagram for combining authentication techniques according to an embodiment of the invention.

FIG. 3 is a block diagram a hardware implementation of the present invention according to an embodiment of the invention.

FIG. 4 is block diagram of a computer system suitable for implementing processes of the present disclosure according to an embodiment of the invention.

### DETAILED DESCRIPTION

Face log in may become a common user authentication technique for computers and other devices. However, it may be possible to defeat such a security system using a photograph or a pre-recorded video. Such hacking can be prevented by adding a real human detection component to the user authentication. While it may also be possible also to prevent hacking by requiring the user to type a password or identify scrambled text, this is less convenient for the user. It also eliminates much of the user convenience of face recognition.

Face log in allows the computer to be aware of the user and the external user environment. The accuracy and security of a face log in system can be enhanced using some technique to make sure that the camera is looking at a real person, not a photograph or prerecorded video or an avatar. While face log in is discussed primarily herein, the described techniques can be applied to any type of technique that authenticates a real person using a camera whether the authentication is based on the appearance of the face, a particular facial feature or dimension, an eye scanner, or even a voice scan.

In one example of the invention, real human behaviors that are hard for machines to simulate in real-time are added to a face log in. The computer uses a camera for input together with a display screen and perhaps a microphone or other sensor to detect whether the observed image is a real human. In one example, the display screen and microphone randomly perform a detection test, the camera records the user reaction as video, and the computer analyzes it and signals an authentication attempt as a pass or a fail.

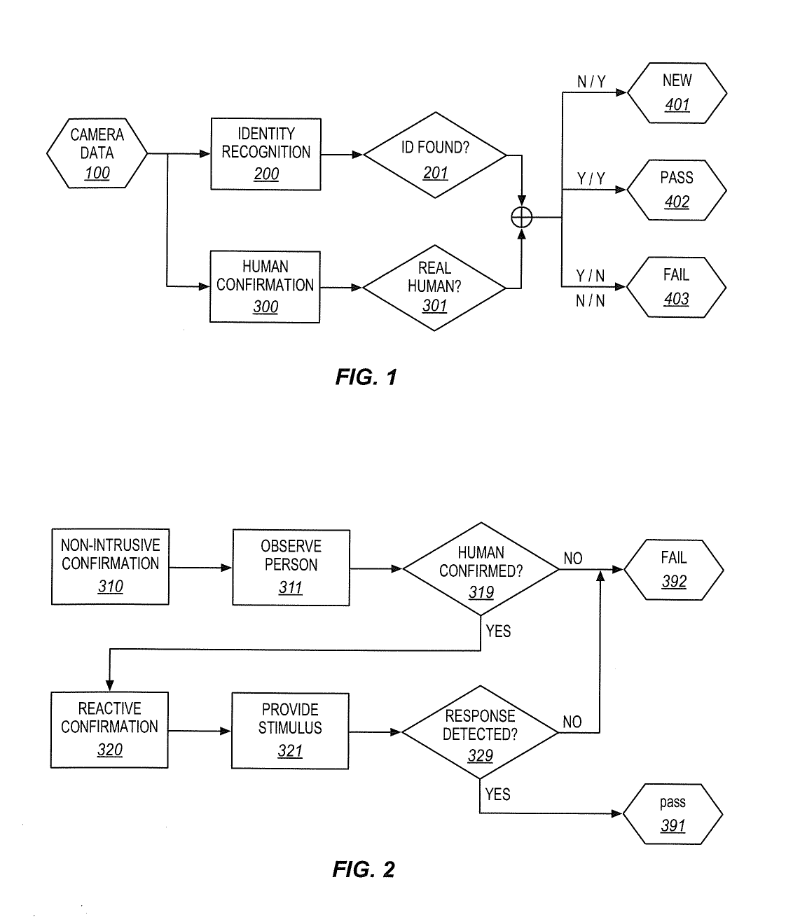

FIG. 1 is a process flow diagram for authenticating a face log in or similar camera-based passive log in. At 100 camera data is received into the system. Other sensor data may also be received, such as microphone data, infrared patterns, etc. The camera data is passed first to an identity recognition block at 200. For a typical face log in at 201 a captured image is compared to stored images of authorized users and, if a match is found, then the face log in is accepted.

The camera data may also be applied to a confirmation test at 300. The system takes additional camera information or other sensor information to confirm that the presented camera data corresponds to a real human and not a simulated presentation intended to defeat the security of the face log in system. At 301, the data is tested for confirmation and a pass or fail result is obtained. If the confirmation test does not provide a yes, then the authentication attempt is failed and the system will not allow a log in whether the face log in was successful or not.

The result of the identity recognition and the human confirmation are combined to provide three possible results. If both tests yield a positive, or yes result then at 402, the authentication is passed. If the identity recognition is a yes, but the human confirmation is a no, then at 403, the authentication attempt is a fail. Similarly, if the face log in provides a no but the human confirmation provides a no, then the authentication attempt is also a fail.

A third option, if the face log in provides a no and the human confirmation provides a yes is to allow a new user account to be established at 401. The third result suggests that the system has detected a real human but that the detected human does not have a log in account for the system. The system may then provide an opportunity for the person to establish a log in account through conventional approaches. Alternatively, the system can go to 403 and fail the attempt.

Three approaches for augmenting a face log in system are described below, however, the invention is not so limited. Each one may be used by itself or in combination with one or more of the other approaches. Each approach can be implemented using equipment that is commonly used or at least commonly available on notebook computers, smart phones, and even some desktop computers.

The first approach is passive and requires no action from the user. It adds another kind of sensing to confirm the face log in. No particular action or reaction from the user is necessary to eliminate many attempts to falsify the face log in. While many other techniques may be used some easily sensed attributes of the user are motion detection (the authorized user will have some movements), 3D-camera observation (the authorized user will not be a 2D picture), and bio-metrics sensing (heart beat, heat signature), among others.

For motion detection, to distinguish a real human from a photograph, a video of the log in face may be taken. A real person moves smoothly but inconsistently. The captured video can be analyzed for non-uniform motion vector distributions. This kind of smooth inconsistent motion can be detected whenever the user turns or tilts the head. If the video is consistent with human motions, then the human confirmation can be passed.

For 3D camera observation, a 3D camera or a camera array can easily determine whether the observed face is a 3D-object or a 2D screen or photograph. To defeat motion authentication system, a video display can be placed in front of the camera to create the appearance of genuine human motion. However, it is difficult to present a 3D video that will be observed as 3D by a camera. The 3D observation avoids this type of cheating.

A simple infra-red camera or other temperature sensitive device can also be used to determine whether the observed face is a warm body or a cool 3D-model. For more sophisticated imaging, the infra-red camera image can be matched against the visible light image to ensure that the observed image has temperature gradients that are consistent with a real face. It is also possible to detect pulses and other natural change in a face using suitably equipped cameras. The 3D, thermal, and pulse rate cameras may be the same camera that performs the face log in equipped with a suitable alternative software mode or it may be a different camera. The face log in and the confirmation cameras may be the same camera used for video conversation and photography or it may be a more specialized camera.

The same sensor may be used in two ways. For example, many digital camera sensors are capable of infra red imaging. This could allow the same camera to be used for both the infra red and the visible light views. In another example, the camera observes not only the face for log in but also the background surrounding the face. If the computer has not moved, then the background for each face log in should be the same. The computer can compare the two images and if the new attempted log in shows the same background, then the log in can be confirmed. As mentioned above, these approaches and those mentioned below can be combined in different ways to make the face log in harder to defeat. Many systems include accelerometers or positioning systems. These can be used to allow the system to determine whether it has been moved or re-oriented.

A second approach to human confirmation adds an involuntary reaction from the user to confirm a face log in. This approach relies upon natural human behavior to confirm that the observed face is actually the authorized user. The involuntary reaction can be a reaction to light, color, sound etc. This is more reliable than trying to determine whether the face in front of the display is a true face.

To obtain an involuntary computer reaction, the computer may initiate an action and then look for an expected corresponding human reaction. If the expected reaction is received then it is confirmed that the log in attempt is by a real human. For example, the computer can flash a light, on the screen or on a related peripheral such as the camera and see if the eyes on the face blink. In another example, the computer can produce a surprising sound using speakers, such as a loud or sudden sound. The face should wince, tremble, or have some other reaction in response. In another example the computer can detect an emotion change to a funny odor.

The particular selection of computer actions may be varied depending on the desired level of security balanced against annoying the user with unpleasant surprises each time the user attempts to log back in. The amount of annoyance can be reduced by using more accurate or sensitive sensors. A very small stimulus to the human can be used to evoke a very small response from the user. In some cases, the user may not even be aware of the involuntary blink, or wince caused by the action of the computer. After some period of use, it may happen that the user becomes accustomed to the stimulus and the involuntary response becomes weak or undetectable. This can be avoided by using a large library of different sounds and visual or flashing effects and then selecting one so that the user does not know what to expect and does not become used to one or a few different stimuli. A random or patterned selection may be used, depending on the particular implementation. A large library of stimuli also enhances the security of the system by making it more difficult for the reaction to be emulated or faked by a machine.

In a third approach, the computer can evoke a specific intentional conscious response from the user. In this case, greetings or questions can be used. These can be informal or personal question or simple requests. As an example, the computer might ask a simple question such as “what day is it today?” or “please tell me your name.” The computer can then analyze the meaning of the content and match the voice of the speaker against a voice pattern. The computer can also observe the face to detect mouth movement on the face that is presented to the face log in system.

As another example, the computer can request a particular response from the user, such as stating “show me your right hand.” The computer can then observe whether a right hand appears in front of the camera. Different types of requests and different questions can be used so that the system cannot be tricked using a prerecorded response.

Such a confirmation process can be made less intrusive by blended it into an exchange that feels like a smart greeting system. In one example, a face log in might be presented. After recognizing the face, the computer might present a personalized greeting, such as “welcome back Mr. Jones” and then follow-up with a simple question. The intentional response can be presented as a pleasant exchange without users being aware of the security aspects of it.

FIG. 2 is an example of a process flow diagram for combining authentication techniques to further secure a face log in system. These operations may all be applied to the process flow diagram of FIG. 1 at block 300. Referring to FIG. 1, at 100 camera data is received from the computer or other device. The camera data is provided to a human confirmation system at block 300. Moving to FIG. 2, at 310, a non intrusive human confirmation is performed. At 311, the person attempted the log in is observed. The observation may be based on any of the types of tests described above, such as a motion test, a 3D test, a temperature test, a pulse test, etc. These may be performed using the face log in image or using another image from the same camera or from a different sensor.

At 319, if the log in attempt is not confirmed to be coming from a human, then there is a failure and at 392, the log in fails. If the log in passes, then the system can move to a reactive confirmation at 320 for additional security. While a single process box 311 is provided for observing the image for human confirmation, there may be multiple tests applied. As an example, a face log in may be tested for both being a 3D image and having a pulse. Any two or more operations may be combined in any way desired depending on the particular embodiment.

At 320 having confirmed the log in attempt through passive means, the system moves to an active confirmation. At 321 a stimulus is provided and at 329 the system determines whether a response to the stimulus has been detected. As mentioned above, the response may be involuntary, such as a wink or wince, or it may be voluntary such as stating a name or raising a hand. If no response is detected at 329, then the log in attempt is failed at 392. On the other hand, if the expected response is detected, then at 391, the log in attempt may be passed. More than one reactive confirmation approach may be used at the same time or in sequence at block 321 before the log in attempt is passed.

As an example the system might ask a question and then listen for a spoken answer together with observing whether the lips of the mouth move at the same time that the audio is received. As another example, the system might flash a light once while it is asking a question. This distracts the user from the flash and allows the system to check for a wink, and then check for an answer to the question. The particular combination may be adapted to suit any particular implementation. In addition, the multiple tests may be staged as in FIG. 2 so that each test must be passed before the next test is provided or the tests may be done on or about the same time so that their successful completion may be received on or about the same time.

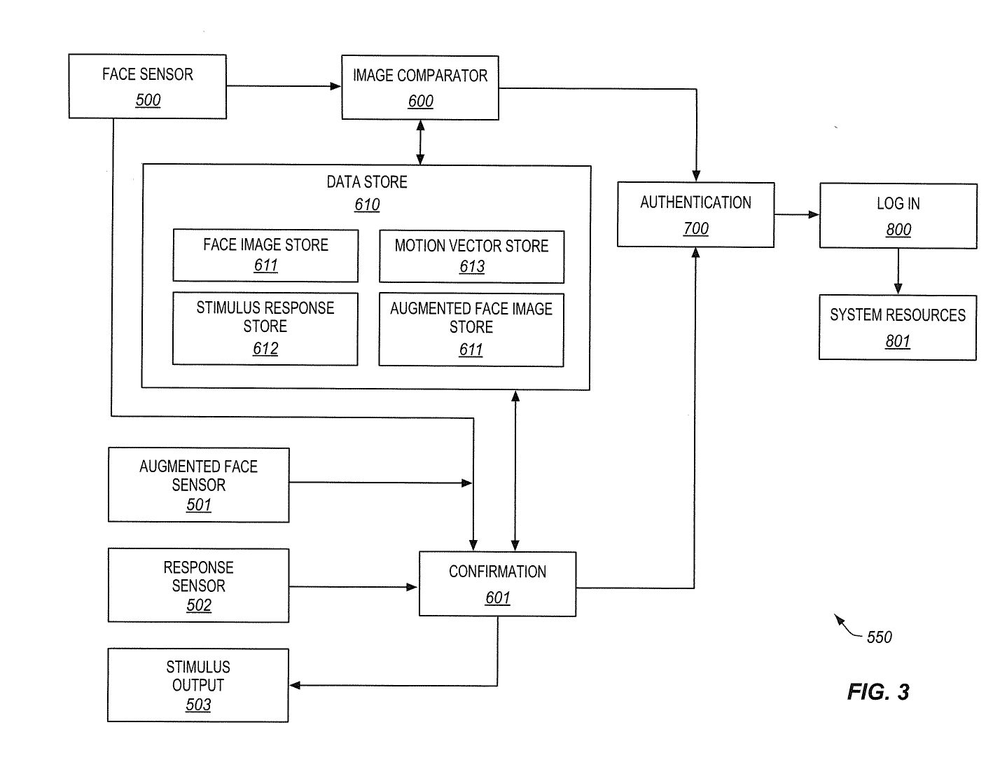

FIG. 3 is a block diagram view of an implementation of the present invention as described in the examples above. A user arrives at the terminal 550 which may be fixed or mobile. The user is then observed by a face sensor 500 for face log in. The face sensor image is provided to an image comparator 600 to compare the observed face image to a library of face images in a face image store 611. The face image store may be a part of separate authentication data resources 610 or a part of the general system resources 801. If the face sensor image matches an image in the face image store, then a pass signal is sent to a user authentication module 700.

To further secure the computer system 550, another authentication system is added before the user is granted a log in 800 and access to the system resources 801. The image from the face sensor 500 may be passed to a confirmation module 601. The confirmation module may then analyze the image to determine whether it is an image of a real person by examining an infrared signature, motion through video, or depth or 3D character. These may be done using the same face sensor 500 or an augmented face sensor 501 may be used in addition to or instead of the face log in face sensor 500. The augmented face sensor may provide 3D viewing, infrared viewing, video viewing, magnified viewing or any other type of viewing, depending on the particular implementation.

For motion vector analysis, the confirmation system 601 may refer to a motion vector store 613 of the data store 610. For other more detailed aspects of the face image, including those from the augmented face sensor, the system may access an augmented face image store 614 of the data store 610. This may include example infrared signatures, depth profiles for 3D imaging, pulse recognition data, and more.

The system 550 may also apply stimulus-response techniques to verify that the user is real person as described above. For this purpose the confirmation module 601 is provided access to a stimulus output 503 to allow the system to produce a stimulus to the user. This stimulus output 503 may be coupled to one or more different hardware resources of the system, such as lights, the display, speakers, and force systems, such as piezoelectric or haptic devices. After a stimulus is provided, the system uses a response sensor 502 to detect a response, if any, from the user to the stimulus. The detected response is sent to the confirmation module 601. The response may be detected using cameras, microphones, or touch sensors.

The results from the confirmation module 601 are passed to the authentication module 700 to be considered together with the face sensor log in module. The authentication makes a determination whether to allow or reject a log in based on the received inputs. If a log in is allowed, then the log in 800 is activated and the user is granted access to the system resources 801.

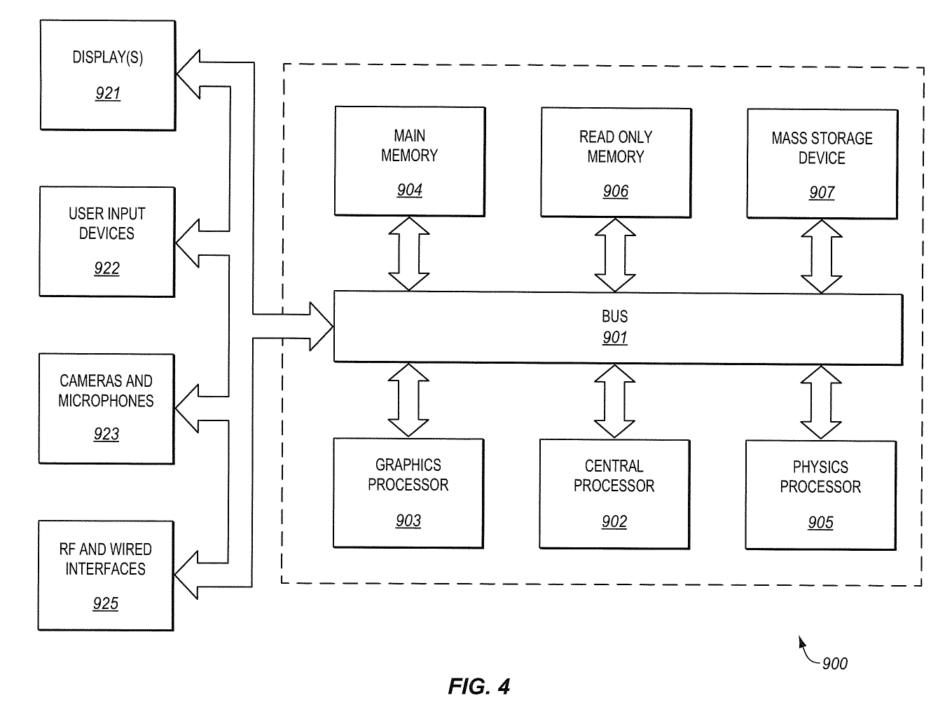

FIG. 4 is a block diagram of a computing system, such as a personal computer, gaming console, smart phone or portable gaming device. The computer system 900 includes a bus or other communication means 901 for communicating information, and a processing means such as a microprocessor 902 coupled with the bus 901 for processing information. The computer system may be augmented with a graphics processor 903 specifically for rendering graphics through parallel pipelines and a physics processor 905 for calculating physics interactions as described above. These processors may be incorporated into the central processor 902 or provided as one or more separate processors.

The computer system 900 further includes a main memory 904, such as a random access memory (RAM) or other dynamic data storage device, coupled to the bus 901 for storing information and instructions to be executed by the processor 902. The main memory also may be used for storing temporary variables or other intermediate information during execution of instructions by the processor. The computer system may also include a nonvolatile memory 906, such as a read only memory (ROM) or other static data storage device coupled to the bus for storing static information and instructions for the processor.

A mass memory 907 such as a magnetic disk, optical disc, or solid state array and its corresponding drive may also be coupled to the bus of the computer system for storing information and instructions. The computer system can also be coupled via the bus to a display device or monitor 921, such as a Liquid Crystal Display (LCD) or Organic Light Emitting Diode (OLED) array, for displaying information to a user. For example, graphical and textual indications of installation status, operations status and other information may be presented to the user on the display device, in addition to the various views and user interactions discussed above.

Typically, user input devices, such as a keyboard with alphanumeric, function and other keys, may be coupled to the bus for communicating information and command selections to the processor. Additional user input devices may include a cursor control input device such as a mouse, a trackball, a trackpad, or cursor direction keys can be coupled to the bus for communicating direction information and command selections to the processor and to control cursor movement on the display 921.

Camera and microphone arrays 923 are coupled to the bus to observe gestures, record audio and video and to receive visual and audio commands as mentioned above.

Communications interfaces 925 are also coupled to the bus 901. The communication interfaces may include a modem, a network interface card, or other well known interface devices, such as those used for coupling to Ethernet, token ring, or other types of physical wired or wireless attachments for purposes of providing a communication link to support a local or wide area network (LAN or WAN), for example. In this manner, the computer system may also be coupled to a number of peripheral devices, other clients, control surfaces or consoles, or servers via a conventional network infrastructure, including an Intranet or the Internet, for example.

A lesser or more equipped system than the example described above may be preferred for certain implementations. Therefore, the configuration of the exemplary systems 900 will vary from implementation to implementation depending upon numerous factors, such as price constraints, performance requirements, technological improvements, or other circumstances. Computer system 900 may refer to a many examples of an electronic device and may include without limitation a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combination thereof.”

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments of the present invention. A machine-readable medium may include, but is not limited to, floppy diskettes, optical disks, CD-ROMs (Compact Disc-Read Only Memories), and magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection). Accordingly, as used herein, a machine-readable medium may, but is not required to, comprise such a carrier wave.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The following examples pertain to further embodiments. Specifics in the examples may be used anywhere in one or more embodiments. In one embodiment, a method includes receiving a camera image of a user at a computer system, testing the image for recognition against a user account, confirming that the image corresponds to a real human, and if the image is authenticated and corresponds to a real human, then authenticating the user to the corresponding user account of the computer system.

Further embodiments include if the image is authenticated and does not correspond to a real human, then refusing authentication and if the image is authenticated and corresponds to a real human then further testing the user to confirm that the image corresponds to a real human and if the further testing is passed then authenticating the user.

In further embodiments, confirming that the image corresponds to real human comprises applying a test to the user that requires no response from the user and further testing the user comprises applying a test that requires a response from the user. The required response may be an involuntary response or a reply to a prompt from the computer system.

In another embodiment, confirming that the image corresponds to a real human comprises applying a plurality of different tests to the user. The plurality of different tests may include a test that requires no response from the user and a test that requires s response from the user. In another embodiment, the test that requires a response includes a test that requires an involuntary response and a test that requires a voluntary response.

In another embodiment testing the image comprises comparing the image to a library of stored user images.

In another embodiment confirming comprises observing the image using a 3D camera to determine whether the user is in 3D.

In another embodiment confirming comprises on or more of measuring infra red radiation from the user to assess a heat signature of the user, recording video of the user and assessing motion vectors in the video, and generating a stimulus and observing a response of the user.

In another embodiment the stimulus comprises a sudden light.

In another embodiment a machine-readable non-transitory medium has instructions that when operated on by the machine cause the machine to perform operations that include receiving a camera image of a user at a computer system, testing the image for recognition against a user account, confirming that the image corresponds to a real human, and if the image is authenticated and corresponds to a real human, then authenticating the user to the corresponding user account of the computer system.

In a further embodiment if the image is authenticated and corresponds to a real human then the user is further tested to confirm that the image corresponds to a real human and if the further testing is passed then the user is authenticated.

In a further embodiment confirming that the image corresponds to real human comprises applying a test to the user that requires no response from the user and further testing the user comprises applying a test that requires a response from the user.

In another embodiment a computer system includes a camera to receive an image of a user at the computer system, a memory to store a library of stored user images in association with user accounts, and a processor to test the received image for recognition against a user account of the memory and to confirm that the image corresponds to a real human, wherein if the image is authenticated and corresponds to a real human, then to authenticate the user to the corresponding user account of the computer system.

In a further embodiment, the computer system also includes a user interface to present a stimulus to the user and to receive an involuntary response from the user and wherein the processor uses the response as further testing of the user to confirm that the image corresponds to a real human.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

1. A method comprising:
receiving a camera image of a face of a user at a face sensor of a computer system for use as face log in;
testing the received camera image for recognition against a face image for a user account;
providing a stimulus to the user from the computer system after recognizing the face image for a user account;
determining whether an involuntary response to the stimulus by the user has been detected by the computer system;
confirming that the image corresponds to a real face of a real human based on the determination; and
if the image of the face is recognized and corresponds to a real human, then authenticating the user to the corresponding user account of the computer system.

2. The method of claim 1, further comprising if the image is authenticated and does not correspond to a real human, then refusing authentication.

3. The method of claim 1, further comprising if the image is authenticated and corresponds to a real human then further testing the user by applying a test that requires a response from the user to confirm that the image corresponds to a real human and if the further testing is passed then authenticating the user.

4. (canceled)

5. (canceled)

6. The method of claim 3, wherein the required response is a reply to a prompt from the computer system.

7. The method of claim 1, wherein confirming that the image corresponds to a real human further comprises applying a plurality of different tests to the user.

8. (canceled)

9. The method of claim 7, wherein the plurality of different tests includes a test that requires a voluntary response.

10. The method of claim 1, wherein testing the image comprises comparing the image to a library of stored user images.

11. The method of claim 1, wherein confirming comprises observing the image using a 3D camera to determine whether the user is in 3D.

12. The method of claim 1, wherein confirming comprises measuring infra red radiation from the user to assess a heat signature of the user.

13. The method of claim 1, wherein confirming comprises recording video of the user and assessing motion vectors in the video.

14. (canceled)

15. The method of claim 1, wherein the stimulus comprises a sudden light.

16. A machine-readable non-transitory medium having instructions that when operated on by the machine cause the machine to perform operations comprising:
receiving a camera image of a face of a user at a face sensor of a computer system for use as face log in;
testing the received camera image for recognition against a face image for a user account;
providing a stimulus to the user from the computer system after recognizing the face image for a user account;
determining whether an involuntary response to the stimulus by the user has been detected by the computer system;
confirming that the image corresponds to a real face of a real human based on the determination; and
if the image of the face is recognized and corresponds to a real human, then authenticating the user to the corresponding user account of the computer system.

17. The medium of claim 16, further comprising if the image is authenticated and corresponds to a real human then further testing the user to confirm that the image corresponds to a real human and if the further testing is passed then authenticating the user.

18. The medium of claim 17, wherein confirming that the image corresponds to a real human comprises applying a test to the user that requires no response from the user and wherein further testing the user comprises applying a test that requires a response from the user.

19. A computer system comprising:
a camera to receive an image of a face of a user at the computer system;
a memory to store a library of stored user face images in association with user accounts;
a stimulus output to produce a stimulus to the user;
a response sensor to detect an involuntary response by the user, if any, to the stimulus; and
a processor to test the received face image for recognition against a face image of a user account of the memory to recognize the user and to confirm that the image corresponds to a real human based on the detected involuntary response, wherein if the image of the face is recognized and corresponds to a real human, then to authenticate the user to the corresponding user account of the computer system.

20. (canceled)

21. The computer system of claim 19, wherein the stimulus output is coupled to one of lights, a display, speakers, or force systems.

22. The method of claim 1, wherein the stimulus comprises one selected from a large library of different effects, selected so that the user does not know what to expect.

23. The method of claim 22, wherein the effects include sound and visual effects.

24. The medium of claim 16, wherein determining comprises detecting whether a face of the user has a reaction to the provided stimulus.

25. The medium of claim 17, wherein further testing the user comprises presenting a personal greeting to the use, asking a question of the user, receiving an intentional response from the user, and then confirming that the intentional response corresponds to the question and the user.
